(19) United States
(12) Patent Application Publication
(10) Pub. No.: US 2024/0031017 A1
(43) Pub. Date: Jan. 25, 2024

(54) COMPUTING TRANSMISSION WINDOWS FOR SATELLITE COMMUNICATIONS

(71) Applicant: Cisco Technology, Inc., San Jose, CA (US)

(72) Inventors: Robert E. Barton, Richmond (CA); Francesco Basile, Pisa (IT); Michael Freed, Pleasanton, CA (US); Yen Chih Lee, San Jose, CA (US); Elango Ganesan, Palo Alto, CA (US)

(21) Appl. No.: 17/869,006

(22) Filed: Jul. 20, 2022

(51) Int. Cl. H04B 7/185; H04L 5/00

(52) U.S. Cl. CPC H04B 7/18584; H04B 7/18589; H04L 5/0073

(57) ABSTRACT

According to one or more embodiments of the disclosure, a device associated with a first cluster of data sources may identify an amount of data from the first cluster of data sources to be sent by the device to a satellite. The device may send, to the satellite, a request for a transmission window that indicates the amount of data to be sent by the device to the satellite. The device may receive, from the satellite, an indication of an assigned transmission window during which the device may transmit data to the satellite. The satellite may compute the assigned transmission window based on the amount of data and such that the assigned transmission window does not overlap an assigned transmission window of a neighboring device associated with a second cluster of data sources. The device may send, during the assigned transmission window, the data towards the satellite.

### TECHNICAL FIELD

The present disclosure relates generally to computing transmission windows for satellite communications.

### BACKGROUND

Satellite communication networks may be utilized to communicate data with a variety of devices. For example, satellite communication networks may be operable to communicate data with terrestrial devices such as sensors and/or other Internet of Things (IoT) devices. An orbiting satellite and/or a constellation of satellites may communicate with these devices, located on or near the surface of the Earth, whenever the satellite passes within a communication range of the device.

For instance, when an orbiting satellite comes into communication range of a device, the device and/or the satellite may attempt to establish a connection and transmit data. In various examples, a particular data transmission frequency may be generally shared among many devices for such communication (e.g., a long range (LoRa) spectrum may be utilized to communicate with a plurality of IoT devices). In some examples, the devices that are attempting to utilize the frequency to communicate can be numerous (e.g., hundreds, thousands, hundreds of thousands, etc.). As such, situations may arise where many devices may transmit data to the satellite at the same time, which may result in the saturation of the satellite's communication channel.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example network;

FIG. 2 illustrates an example network device/node;

FIGS. 3A-3B illustrate an example satellite communication network for computing transmission windows for satellite communication;

FIGS. 4A-4C illustrate an example of transmission window computation in a satellite communication network; and

FIG. 5 illustrates an example simplified procedure for computing transmission windows for satellite communications.

### DESCRIPTION OF EXAMPLE EMBODIMENTS

### Overview

According to one or more embodiments of the disclosure, a device associated with a first cluster of data sources may identify an amount of data from the first cluster of data sources to be sent by the device to a satellite. The device may send, to the satellite, a request for a transmission window that indicates the amount of data to be sent by the device to the satellite. The device may receive, from the satellite, an indication of an assigned transmission window during which the device may transmit data to the satellite, wherein the satellite computes the assigned transmission window of the device based on the amount of data to be sent by the device to the satellite and such that the assigned transmission window of the device does not overlap an assigned transmission window of a neighboring device associated with a second cluster of data sources. The device may send, during the assigned transmission window of the device, the data from the first cluster of data sources towards the satellite.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge/fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

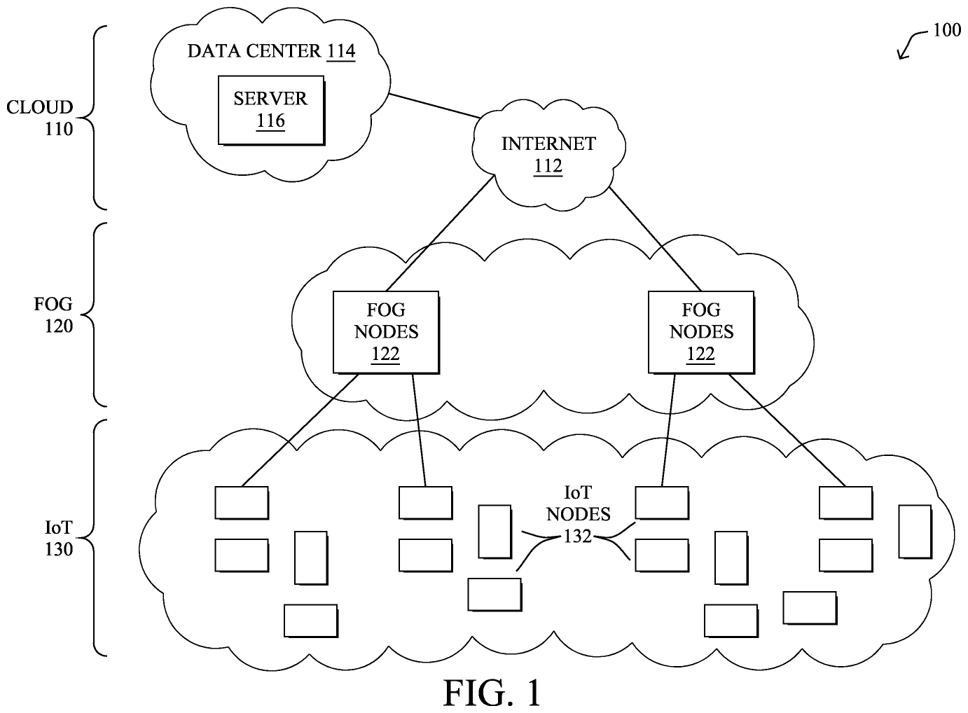

FIG. 1 is a schematic block diagram of an example simplified computer network 100 illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely cloud layer 110, fog layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT device layer 130. For example, fog nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), powerline communication protocols, or other shared-media protocols where appropriate. In this context, a protocol consists of a set of rules defining how the nodes interact with each other.

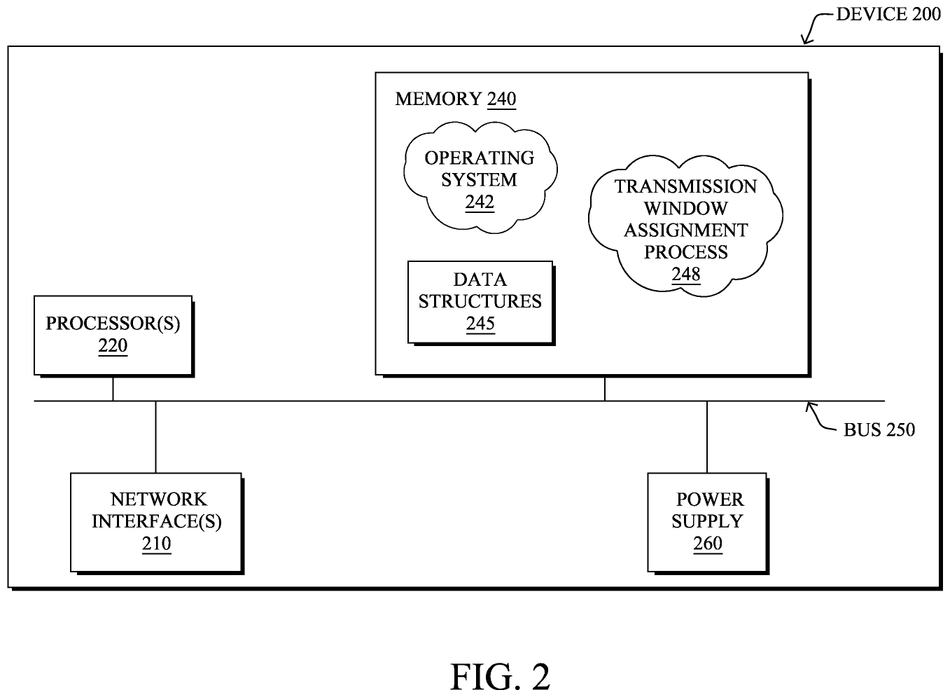

FIG. 2 is a schematic block diagram of an example node/device 200 (e.g., an apparatus) that may be used with one or more embodiments described herein. As shown, device 200 may comprise one or more communication interfaces 210 (e.g., wired, wireless, etc.), at least one processor 220, and a memory 240 interconnected by a system bus 250, as well as a power supply 260 (e.g., battery, plug-in, etc.). In various embodiments, node/device 200 may take the form of a networking device, such as a switch, router, a relay, a cluster head, or the like.

Communication interface(s) 210 include the mechanical, electrical, and signaling circuitry for communicating data over a communication link. To this end, communication interface(s) 210 may be configured to transmit and/or receive data using a variety of different communication protocols, such as Ethernet, TCP/IP, UDP, etc. Note that the device 200 may have multiple different types of communication interface(s) 210, e.g., wireless and wired/physical connections, and that the view herein is merely for illustration.

The memory 240 comprises a plurality of storage locations that are addressable by the processor(s) 220 and the communication interface(s) 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a transmission window assignment process 248, as detailed below.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

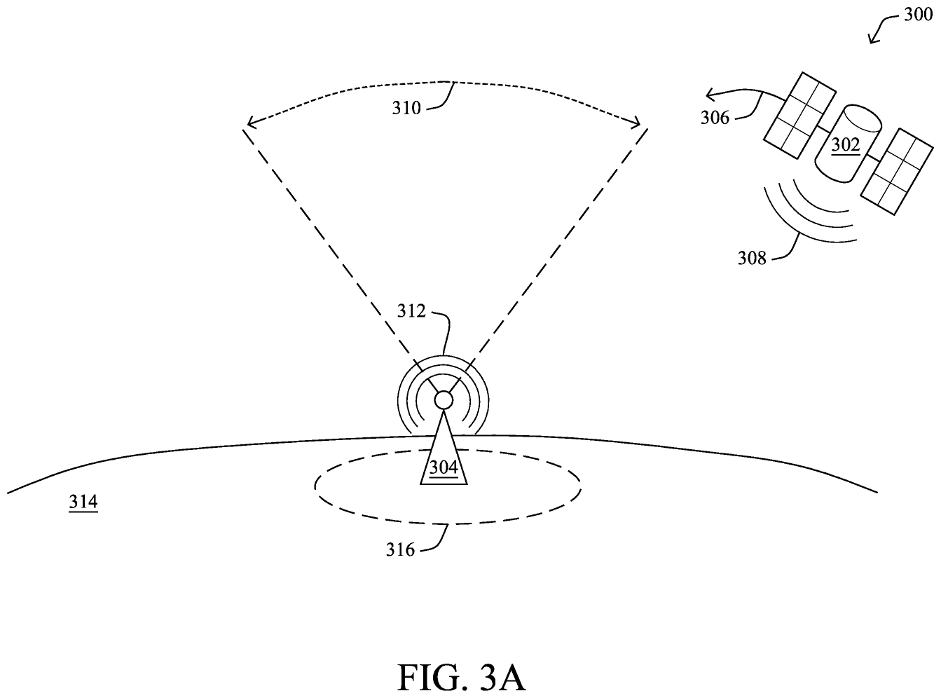

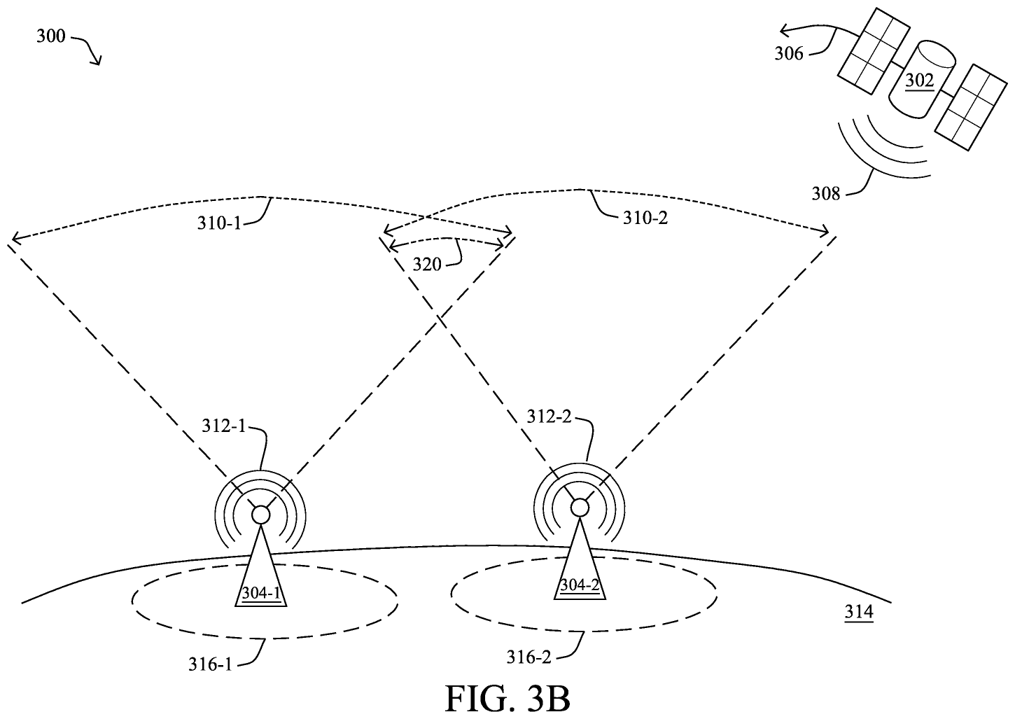

FIGS. 3A-3B are schematic block diagrams of an example of a satellite communication network 300 that may be used with one or more embodiments described herein. The satellite communication network 300 may include satellite 302. Satellite 302 may include a communications device which orbits a planet and/or communicates with an Earth-based device (e.g., device 304) by sending a signal 308 encoded with information. Satellite 302 may be a single satellite and/or a constellation of satellites configured to communicate with Earth-based devices.

In various embodiments, satellite 302 may be a low-earth orbit (LEO) satellite. As an LEO satellite, satellite 302 may orbit at an altitude less than about one-third of the radius of Earth. For example, satellite 302 may travel in an orbit less than 2,000 kilometers (Km) above the surface of the Earth (e.g., between 600 and 1200 Km above Earth, etc.). Satellite 302 may orbit at a speed of approximately 7 Km/s-8 Km/s. Satellite 302 may complete an orbit of Earth in less than 128 minutes (e.g., approximately every 90 minutes) orbiting Earth multiple times per day (e.g., 11 or more orbits). In some specific examples, at a circular orbit altitude of 200 Km, satellite 302 may travel at 7.79 Km/s (28,000 Km/h); and at a 1,500 Km altitude, satellite 302 may travel at 7.12 Km/s (25,600 Km/h).

Satellite communication network 300 may include device 304. Device 304 may be a device configured to communicate with satellite 302. For example, device 304 may include components operable to send signals to and/or receive signals from satellite 302. Device 304 may, in some embodiments, be an IoT sensor. For example, device 304 may be a data source that includes components operable to collect measurements from its environment and communicate those measurements as data to satellite 302.

Device 304 may additionally or alternatively be a communication relay for a network of sensors. For example, device 304 may include components operable to communicate with other devices, including IoT sensors, in their network (e.g., wired, wireless, etc.) and relay their sensor data to satellite 302 and/or relay signal received from satellite 302 to devices in their network. In such examples, device 304 may be a conduit for communicating information from other data sources in the network to satellite 302.

In various examples, device 304 may be a signal-relaying cluster head (CH) of a cluster 316 of devices. For example, when terrestrial IoT sensors are deployed, they are generally done so in clusters, grouped according to their geographical region. For example, if ground sensors are deployed across a city, all the sensors in this city may belong to a single cluster.

In general, a cluster may be defined as a group of sensors belonging to the same organization (customer) which are generally within range of each other. As a method to conserve energy and optimize transmission performance, clusters may have a central relay node (e.g., CH), which may be responsible for aggregating data from data sources in the cluster 316 and relaying it to satellite 302. As IoT sensors generate data within the cluster, they may send it to the CH. The CH may aggregate and queue these messages until a time when satellite 302 passes overhead in its SIA 310 and then transmit the data to satellite 302. The CH may function as a store-and-forward relay point for the other devices in the cluster.

Device 304 may be terrestrial-based, in various embodiments. For example, device 304 may be located on or near the surface of the Earth 314 and collect data from its local environment. Satellite 302 may be traveling a particular direction 306 relative to the surface of the Earth 314 and/or relative to the position of device 304 on the Earth's surface. For example, in FIGS. 3A-3B, satellite 302 is illustrated moving in a right to left direction 306 across the page and over device 304.

Satellite 302 may send signal 308 (e.g., satellite beam, etc.) encoded with information to device 304. Likewise, device 304 may send signal 312 encoded with information to satellite 302. In order for either of these communications to be received, satellite 302 and device 304 may need to be within communication range to one another and/or to any intervening relaying devices. To be in communication range, satellite 302 and device 304 (or a relaying device) must be aligned within each other's signal path and/or signal receiving area.

In various embodiments, being within communication range may mean being within a line-of-sight (LoS) of one another. For example, when device 304 is operated it may have an LoS also known as Sky Interesting Area (SIA) 310. SIA 310 may include an area extending upward and/or outward from device 304. SIA 310 may include the area within which a signal from device 304 travels and/or within which a signal from satellite 302 may be detected and/or received. Therefore, in order for satellite 302 and device 304 to communicate with one another, satellite 302 may need to be flying overhead in a position where its signal 308 travels within SIA 310 and/or where its signal detection LoS aligns with an area where a signal 312 from device 304 is traveling which can also be SIA 310 (e.g., within communication range).

At LEO satellite altitudes, only a very small portion of the Earth may be visible to satellite 302 at any given time. Further, due to the high velocity of such satellites, a location on Earth may only be within communication range of satellite 302 for a short window of time (e.g., around ten minutes) during each fly-over of the location by satellite 302. Therefore, a potential transmission window (pTxW) within which the satellite 302 is in an appropriate position for sending and/or receiving signals within SIA 310 of device 304 may be relatively short and occur at various periods throughout a day (e.g., once per aligning orbit, every 90-120 minutes, etc.). That is, a pTxW for communication between device 304 and satellite 302 may open when satellite 302 aligns within SIA 310 during its fly-over pass and close when satellite 302 exits SIA 310.

In some circumstances, more than one device (e.g., first device 304-1 and second device 304-2) may be utilized in satellite communication network 300, such as is illustrated in FIG. 3B. These devices may be standalone devices, associated with a same cluster, and/or associated with different clusters (e.g., first cluster 316-1 and second cluster 316-2) in various examples.

The devices may be located within a close-enough geographic proximity (e.g., within a same city, etc.) that their respective SIAs (e.g., first SIA 310-1 of first device 304-1 and second SIA 310-2 of second device 304-2) overlap to some extent (e.g., fully, partially, etc.). In such examples, satellite 302 may be within communication range (e.g., within the SIA) of both devices when it is traveling through the overlapping region 320 of their respective SIAs. While only two devices are illustrated in FIG. 3B in order to provide a simplified illustration, it should be understood that the amount of devices sharing a common overlapping region of their respective SIAs can be any amount (e.g., tens, hundreds, thousands, tens of thousands, hundreds of thousands, etc.).

As noted above, when multiple devices (e.g., first device 304-1 and second device 304-2) are simultaneously transmitting data to satellite 302 (e.g., when satellite 302 is passing through the overlapping region 320 of their respective SIAs), the data communication channel (e.g., a shared LoRa transmission frequency) of satellite 302 may become saturated. The saturation may result in system errors and/or communication failures between the devices and the satellite 302. These errors and failures may degrade the operation of satellite communication network 300 and/or any systems (e.g., IoT services) relying on those communications.

Hidden node data communication in satellite communication network 300 may lie at the root of these channel saturating data collisions. For example, a first device (e.g., first device 304-1) and/or cluster (e.g., first cluster 316-1) may not be aware of the existence (e.g., the location of, the SIA of, the data communication configuration of, etc.) of a neighboring device (e.g., second device 304-2) and/or cluster (e.g., second cluster 316-2). That is, the existence and operations of neighboring devices and/or clusters may be “hidden” from one another in that the neighbors are not aware of each other and/or are not aware that they share an overlapping region 320 of their respective SIAs in common. From their perspective, their actual transmission windows (TxWs) may be assumed to be equivalent to their pTxWs. For example, the neighboring devices and/or clusters may initially assume that their TxWs are opened from the point at which satellite 302 appears on the horizon until the point it disappears on the other horizon. Basically, they may assume that their TxWs are coextensive with their SIAs. As a result of their ignorance of sharing an overlapping region 320 of their respective SIAs in common, a first device (e.g., first device 304-1) and/or cluster (e.g., first cluster 316-1) and a neighboring device (e.g., second device 304-2) and/or cluster (e.g., second cluster 316-2) may accidently simultaneously transmit to satellite 302 while it is within the overlapping region 320 of their respective SIAs causing a saturation of the data communication channel of satellite 302.

Some entirely terrestrial communication systems may utilize a listen-before-talk approach to try and avoid transmitting at the same time as another node and causing a communication collision. However, in the satellite communication case, this approach may not be feasible because devices may not be equipped with interfaces listening at the frequencies used for the uplink transmission and/or the devices may be too far apart from each other to communicate directly with one another.

With fast moving LEO satellites quickly traversing the sky, a pTxW for a device may be relatively short (e.g., ten minutes, etc.). However, within this same short time window, there may be several distinct devices and/or clusters which may be trying to transmit data to the satellite at the same time and on the same channel. These simultaneous transmissions may cause data communication collisions and an increased overall latency, thereby reducing performance of the system.

As the density of devices grows above a certain threshold, if a retransmission mechanism is present, the communication channel may quickly saturate. In a deployment where IoT sensors are within close proximity to each other, mechanisms such as CSMA/CA, Aloha, or Slotted Aloha may be used. These collision avoidance mechanisms allow a transmitter to back off for a random time and then attempt to retransmit, thus limiting the chance of a collision. However, with an LEO satellite moving overhead, a device hearing another transmission from a distant device is unlikely.

In cases such as this, it may be that only satellite 302 is aware that multiple devices (e.g., first device 304-1 and second device 304-2) are attempting to transmit at the same time (e.g., within overlapping region 320). However, currently there are no mechanisms for a satellite to compute and/or automatically restructure the colliding data communications of neighboring devices and/or clusters of devices that are distant yet have overlapping SIAs such that these collisions can be avoided.

### Computing Transmission Windows for Satellite Communications

The techniques herein introduce mechanisms that allow a satellite to utilize its holistic knowledge of satellite communication network participants and their configurations to allocate communication resources to devices and/or clusters of devices, such as time slots, frequencies/channels, spreading code information, or the like.

Illustratively, the techniques described herein may be performed by hardware, software, and/or firmware, such as in accordance with transmission window assignment process 248, which may include computer executable instructions executed by the processor 220 (or independent processor of interfaces 210) to perform functions relating to the techniques described herein.

Specifically, according to various embodiments a device associated with a first cluster of data sources may identify an amount of data from the first cluster of data sources to be sent by the device to a satellite. The device may send, to the satellite, a request for a transmission window that indicates the amount of data to be sent by the device to the satellite. The device may receive, from the satellite, an indication of an assigned transmission window during which the device may transmit data to the satellite, wherein the satellite computes the assigned transmission window of the device based on the amount of data to be sent by the device to the satellite and such that the assigned transmission window of the device does not overlap an assigned transmission window of a neighboring device associated with a second cluster of data sources. The device may send, during the assigned transmission window of the device, the data from the first cluster of data sources towards the satellite.

Operationally, and according to various embodiments, a mechanism is described which allows a device to request and/or receive allocations of communication resources from a satellite. The allocations may be configured in a manner that avoids simultaneous and/or colliding data communications. In addition, the allocations may be dynamically adjusted to account for changing satellite network conditions and/or participants.

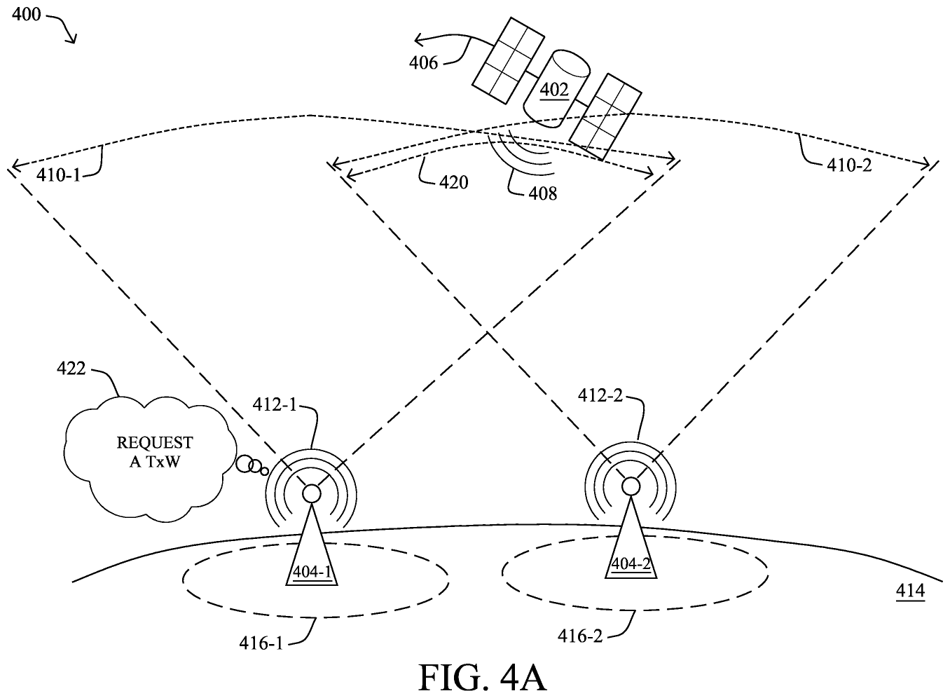

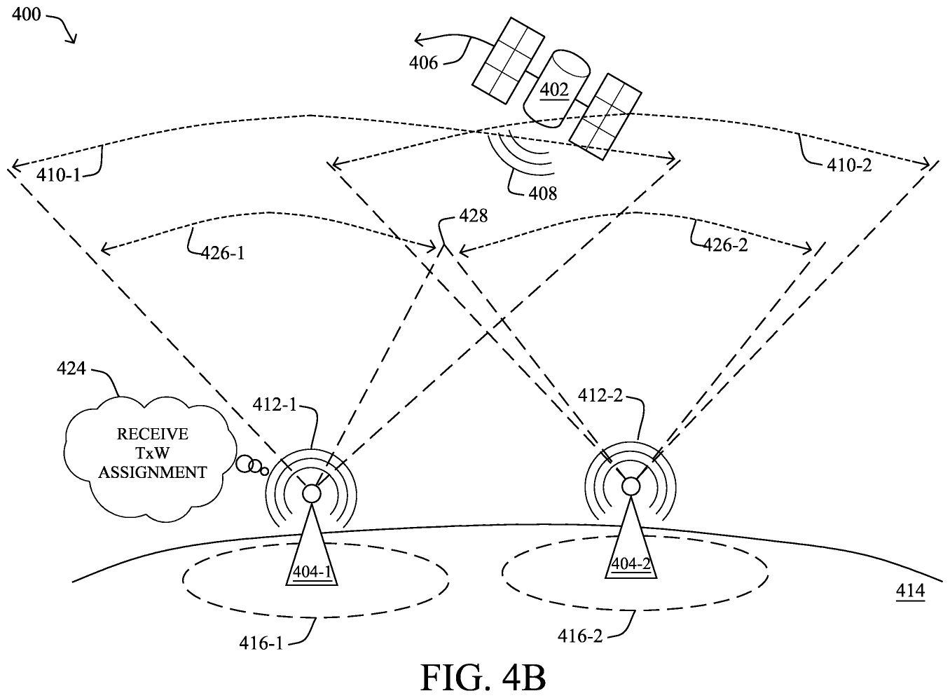

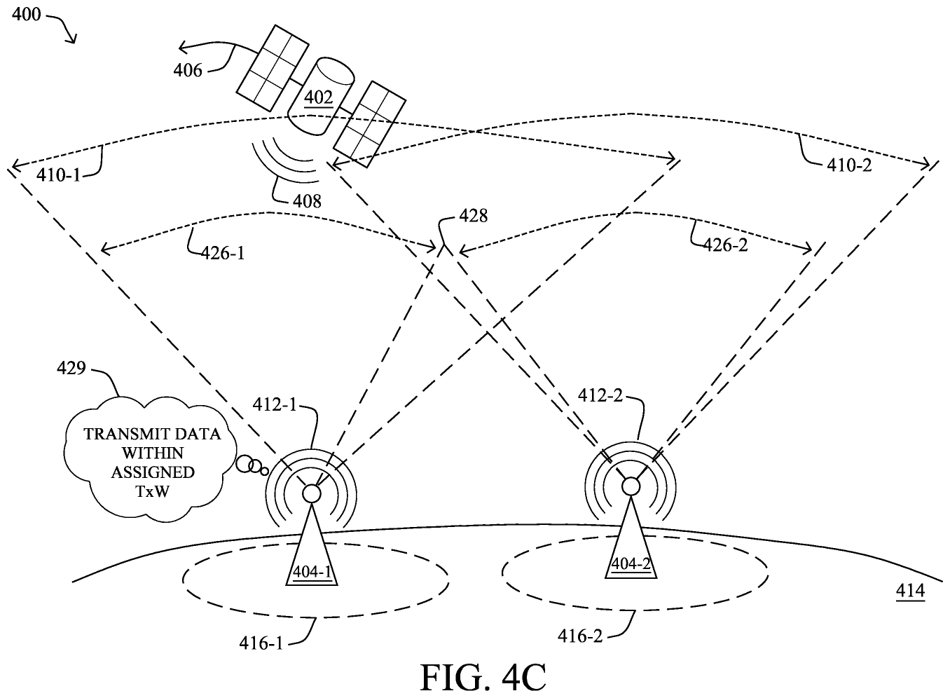

For example, FIG. 4A-4C illustrates an example simplified procedure for computing transmission windows for satellite communications in a satellite communication network 400. Satellite communication network 400 may include satellite 402 traveling in a particular direction 406. Satellite 402 may be an LEO satellite. Satellite 402 may be a portion of a constellation of LEO satellites. Satellite 402 may transmit data via signal 408.

Additionally, satellite communication network 400 may include devices (e.g., first device 404-1 and second device 404-2). The deices may be sensors, such as IoT sensors (e.g., temperature sensors, humidity sensors, pressure sensors, proximity sensors, level sensors, accelerometers, gyroscopes, gas sensors, infrared sensors, optical sensors, etc.). Additionally, or alternatively, the devices may be communication relays. For example, a particular device may be a relay for capturing sensor data detected by its own sensor component and/or detected by other sensor devices and communicating that data to satellite 402. In some examples, other sensors may collect sensor data by their sensing component and communicate the data to the relay device for storage and/or communication to satellite 402.

In various embodiments, devices may be associated with a particular cluster (e.g., first device 404-1 associated with first cluster 416-1 or second device 404-2 associated with second cluster 416-2). Although, it should be appreciated that the same approaches described herein are applicable to stand-alone devices such as ground terminal sensors which may or may not be part of a cluster.

A cluster may include a group of devices (e.g., a network of IoT sensors) that are physically and/or logically grouped together distinct from other clusters. For example, first cluster 416-1 may include a first group of devices that are physically and/or logically distinct from those of second cluster 416-2. In various embodiments, the devices may be cluster heads (CH) for their respective cluster. For example, first device 404-1 may operate as a CH for first cluster 416-1 and second device 404-2 may operate as a CH for second cluster 416-2. Therefore, the devices may aggregate and/or queue data generated by and/or received from the other devices (e.g., data sources) of their respective clusters until a time when satellite 402 passes overhead within their respective SIA and they can transmit their cluster's data to satellite 402 (e.g., devices may act as a store-and-forward relay point for their cluster). The devices may communicate this data via signal (e.g., first device 404-1 by first signal 412-1 and second device 404-2 by second signal 412-2).

As previously described, the devices may each have a corresponding SIA. For example, first device 404-1 may have a first SIA 410-1 which defines its potential communication range. First device 404-1 may have the ability to transmit first signal 412-1 to and/or receive signal 408 from satellite 402, when satellite 402 is passing through first SIA 410-1. Likewise, second device 404-2 may have a second SIA 410-2 which defines its potential communication range with satellite 402. In various embodiments, first SIA 410-1 of first device 404-1 may partially or fully overlap with second SIA 410-2 of second device 404-2. As such, an overlapping region 420 may exist between first SIA 410-1 and second SIA 410-2. However, neither first device 404-1 and/or second device 404-2 may be aware of the other, the other's cluster, the other's SIA, overlapping region 420, etc. That is, first device 404-1 and second device 404-2 may be hidden nodes of satellite communication network 400 with respect to one another.

Each device may discover its respective SIA. For example, each device may discover its SIA via a manual configuration, periodic signal sampling, learning from a neighboring device, from an orbital details table (ODT) transmitted by satellite 402, etc. However, upon learning its SIA, a device may not automatically begin transmitting all its data as normal when satellite 402 enters its SIA. Instead, a device may utilize the process outlined below. While examples of this process are outlined with respect to exchanges between first device 404-1 and/or second device 404-2 and satellite 402, the following examples are not limited to a specific device and/or are not limited to executing the process one device at a time or in any specific order.

A device (e.g., first device 404-1) may identify an amount of data that it will send to satellite 402. For example, first device 404-1 may determine an amount of data in its transmission queue awaiting transmission to satellite 402. In examples where first device 404-1 is a CH, the amount of data may be the amount of data collected by and/or received from various other data sources in its associated first cluster 416-1. For example, where first cluster 416-1 includes a group of sensors, the amount of data may include the amount of sensor data held in a transmission queue of CH that has been captured by the sensors of first cluster 416-1 since joining satellite communication network 400 and/or since a prior transmission of sensor data to satellite 402.

The device may request an allocation of communication resources (e.g., a TxW, a data transmission time slot, a data transmission frequency/channel, spreading code information, etc.) from satellite 402 as satellite 402 enters its SIA. For example, first device 404-1 may, at 422, send a request to satellite 402 entering first SIA 410-1 for an assignment of a TxW. In some examples, first device 404-1 may not begin transmitting the data from its queue to satellite 402 until it has been assigned a TxW.

In some instances, a device may send its request while satellite 402 is communicating with a neighboring device (e.g., second device 404-2) and/or while satellite 402 is traveling within a portion of the device's SIA that overlaps with an SIA and/or a TxW of a neighboring device. For example, first device 404-1 may send the request to satellite 402 while satellite 402 is traveling within overlapping region 420 of first SIA 410-1 and second SIA 410-2. Since satellite 402 is simultaneously in both first SIA 410-1 and second SIA 410-2 during this period of its orbit, first device 404-1 may transmit its request while second device 404-2 is transmitting it data to satellite 402 on the same channel at the same time. The first device 404-1 and second device 404-2 may be hidden nodes with respect to one another, with the transmissions of second device 404-2 being unknown and/or undetected by first device 404-1 and vice versa.

However, the request may be configured to minimize the potential for data collisions during such simultaneous communication. For example, the request may only include a small amount of data relative to the amount of data communicated by first device 404-1 and/or second device 404-2 during the course of its regular operations (e.g., a negligible proportion of a data communication channel used to communicate data from data sources of each cluster within its assigned TxW). The relatively small payload of the request may reduce the probability of it saturating the communication channel in instances where a neighboring device is communicating its data over the same channel at the same time.

In alternative embodiments, the request and subsequent negotiation process may be performed over a dedicated negotiation channel. The negotiation channel may not be used for transmitting the other data (e.g., sensor data collected from data sources) in order to avoid main data channel saturation.

The request may include a header to a media access control (MAC) frame transmitted to satellite 402. The header may include an identifier. The identifier may identify the requesting device and/or a cluster where the frame originated. For example, a TxW request sent from first device 404-1 may include a header to its MAC frame including a cluster ID field identifying the first cluster 416-1 as the source of the request frame.

The cluster ID field of the MAC frame may be encoded as a mechanism for satellite 402 to distinguish between transmission request from different devices and/or different clusters. Satellite 402 may cross-reference the cluster ID against an index of all existing and/or planned clusters in satellite communication network 400. The index may include the position on Earth (e.g., longitude, latitude, etc.) of each of these clusters.

The request may additionally or alternatively include an indication of the amount of data that the device sending the request wants to transmit to satellite 402. For example, first device 404-1 may send, along with its cluster ID, the amount of data waiting in transmit queue. As previously described, since satellite 402 may pass over for relatively short periods each day, data collected from data sources in first cluster 416-1 during the intervening time periods may be sent to device 404-1 and/or stored in a transmit queue awaiting the next flyover period of satellite 402 during which it may be transmitted to satellite 402. Thus, the data amount indication provided by first device 404-1 may inform satellite 402 as to the amount of data that first device 404-1 wants to send within the TxW that it is requesting.

Satellite 402 may utilize the information received and/or indicated by the request to determine an allocation of communication resources to assign to the requesting device and/or its associated cluster. For example, satellite 402 may calculate a TxW to assign to the requesting device and/or its associated cluster. In these calculations, satellite 402 may consider communication resource allocations to other devices and/or other clusters in satellite communication network 400 and/or communication resource requests therefrom.

In some examples, an allocation of communication resource may be based on a location of the requesting device and/or its associated cluster. For example, upon receiving the request for the TxW assignment, satellite 402 may examine the geographic proximity of the device sending it. For example, satellite 402 may determine its geographic proximity to first device 404-1 and/or first cluster 416-1 sending a TxW request at one or more periods during its orbit from that request. In various examples, satellite 402 may determine, based on the location and/or proximity data, an SIA of first device 404-1, as well.

A largest possible TxW for the requesting device may be calculated by satellite 402 based on the determined location and/or proximity. A largest possible TxW may include a TxW that has a longest duration and/or a largest area or proportion of an SIA for the requesting device. For example, satellite 402 may utilize the determined location and/or proximity of first device 404-1 as part of a computation to determine a largest possible TxW for first device 404-1. Satellite 402 may additionally or alternatively compute the largest TxW for first device 404-1 based on a current velocity and/or orbital trajectory of satellite 402 and/or determined or communicated edges of first SIA 410-1.

Since each TxW may be calculated based on the unique characteristics of the requesting device and/or its relationship to satellite 402, a largest TxW of each device in satellite communication network 400 may be distinct. In some examples, the largest possible TxW for a device may correspond to the entire extent of its SIA. The largest possible TxW for a device may be the TxW initially assigned to the requesting device and/or may be a starting point to calculate an assigned TxW that optimizes data communication across the satellite communication network 400.

As satellite 402 orbits through the various device and/or cluster SIAs making up satellite communication network 400, it may identify various devices and/or their associated clusters that have overlapping SIAs. For example, satellite 402 may identify that first SIA 410-1 of first device 404-1 and second SIA 410-2 of second device 404-2 overlap (e.g., at overlapping region 420). In these instances, if the TxW assigned to first device 404-1 and/or first cluster 416-1 and the TxW assigned to second device 404-2 and/or second cluster 416-2 include overlapping region 420, simultaneous transmission by the first device 404-1 and/or second device 404-2 within overlapping region 420 may occur. This simultaneous transmission may result in data transmission collisions and performance degradation resulting from saturation of the communication channel of satellite 402.

Satellite 402 may calculate a TxW to be assigned to a requesting device and/or others in the satellite communication network 400 which prevents the colliding transmissions. For example, satellite 402 may calculate a non-colliding, unique, and/or deterministic TxW for each device and/or cluster in satellite communication network 400. In various embodiments, satellite 402 may calculate these TxWs such that they collectively optimize data throughput across the entirety of satellite communication network 400.

Satellite 402 may calculate the TxW to be assigned to a requesting device based on a calculated and/or measured latency of a data transmission from that device to satellite 402. The latency may be determined as a function of the distance (e.g., geographic proximity) between the transmitting device and the receiving satellite 402 when the transmission is attempted. For example, as satellite 402 gets closer to first device 404-1, the latency of transmission between the two may become lower, which may result in greater data throughput and/or system performance. Therefore, data latency of data transmissions from first device 404-1 may be calculated as a function representing its data flow vs. its geographic proximity to satellite 402 distributed according to a Poisson distribution. As such, an optimal data throughput (e.g., highest volume and/or rate of data transmission relative to data throughput at other portions of first SIA 410-1) may occur as satellite 402 approaches and/or arrives at a zenith above first device 404-1 and diminish as it approaches the edges of first SIA 410-1.

Additionally, satellite 402 may calculate the TxW to be assigned to the requesting device based on the amount of data (e.g., the data collected by the device and/or by the devices of its associated cluster) that it needs to send to satellite 402. Recall that the requesting device may include an indication of the amount of data it has to send to satellite 402 in its request. Therefore, satellite 402 may examine the amount of data that a requesting device needs to transmit (e.g., an amount of data in its transmit queue) as specified in its request and calculate a TxW that will facilitate all or part of that transmission in a flyover.

In various embodiments, the TxW to be assigned to the requesting device may be calculated from both the latency of transmission and the amount of data to be transmitted. For example, by identifying an amount of data to be transmitted and the various data transmission rates achievable over an SIA of a requesting device, satellite 402 may be able to identify one or more windows within the SIA during which all or part of this data may be transmitted.

Additionally, the data transmission demands of other devices and/or clusters in satellite communication network 400 and/or the overall data throughput of satellite communication network 400 may be utilized in calculating an optimal TxW for the requesting device and/or satellite communication network 400. For example, the TxW to be assigned to a device may be computed utilizing a throughput optimization function that allows the largest quantity of data to be transmitted by limiting the TxW of each device of the satellite communication network 400 such that a maximum amount of data may be transmitted across the whole of satellite communication network 400. The resulting TxW to be assigned to a requesting device may be less than or equal to the SIA of the device. As discussed in greater detail below, the resulting TxW may include an allocation of respective portions of an overlapping region 420 of SIAs among the devices with the overlapping SIAs.

In various embodiments, after an initial flyover of satellite communication network, a TxW to be assigned to each of the devices may be calculated. Satellite 402 may then assign the calculated TxW to each of the devices. Assigning the TxW may include informing the device receiving the assignment of when it may begin transmitting and when it must stop transmitting, thus defining a total TxW that aligns to a portion of its SIA.

Each device may receive its communication resource assignment from satellite 402. For example, first device 404-1 may receive its assignment of first TxW 426-1 from satellite 402 and second device 404-2 may receive its assignment of second TxW 426-2 from satellite 402.

The edges of the TxW assignments (e.g., where a TxW begins and/or where a TxW ends) may define a handoff point 428 where a handoff from one device or cluster to a neighboring device or cluster is intended to occur. The TxW assignments may be transmitted to the devices before they begin transmitting the data in their transmit queue. For example, the TxW assignments may be transmitted to and/or received by a device contemporaneous with and/or immediately upon satellite 402 entering its SIA.

In some instances, during an initial flyover there may be no competing devices and/or clusters (e.g., no devices or clusters with overlapping SIAs, etc.). In these instances, the non-competing devices and/or clusters may be assigned an initial TxW that substantially aligns with their entire SIA window. However, while this transmission is still under way, a neighboring device and/or cluster may come into range and/or begin requesting a TxW assignment. In such instances, satellite 402 may calculate a TxW to be assigned for the existing device and/or a cluster (e.g., to modify and/or replace its initial TxW)) and/or calculate a new TxW to be assigned to the neighboring device or cluster.

These TxWs may be calculated based an amount of data that the newly introduces neighboring device and/or cluster has indicated that it needs to send and/or the geographic proximity of satellite 402 to the neighboring device and/or cluster across its orbit. Satellite 402 may calculate the new TxW for the neighboring device from these variables in addition to modifications to the initial TxW for the existing device. The modified TxW for the existing device may be utilized after the current window closes or the initial TxW assignment that it is operating within during its modification may be shortened and replaced with the modified TxW immediately.

For example, say that second device 404-2 and/or second cluster 416-2 is initially operating with an initial TxW that aligns with second SIA 410-2. That is, second device 404-2 may be transmitting data collected from data sources in second cluster 416-2 to satellite 402 within this initial TxW spanning the entirety of SIA 410-2. Then, first device 404-1 and/or first cluster 416-1 may come into communication range of satellite 402 (e.g., satellite 402 may enter first SIA 410-1) and/or begin requesting a TxW assignment.

Satellite 402 may calculate, based on amount of data that first device 404-1 has indicated it has to transmit and/or a geographic proximity of first device 404-1 to satellite 402, first TxW 426 to be assigned to first device 404-1 and/or second TxW 426-2 to be assigned to second device 404-2 as a modification and/or replace of its initially assigned TxW. The calculated first TxW 426 and/or second TxW 426-2 may be defined such that a handoff point 428 resides within an overlapping region 420 shared by first SIA 410-1 and second SIA 410-2. By defining this handoff point 428 within the overlapping region 420, satellite 402 may define a first TxW 426-1 for first device 404-1 that is less than first SIA 410-1 and/or a second TxW 426-2 for second device 404-2 that is less than second SIA 410-2, effectively abbreviating both of their TxWs from their total potential TxW defined by their respective SIAs. This abbreviation may avoid data communication collisions and/or data channel saturation. As mentioned above, the transmission of data by second device 404-2 may be shortened while second device 404-2 is still transmitting within its initial TxW.

After a series of flyovers, satellite 402 may record how much data each device and/or cluster typically sends (e.g., an average data transmission amount of each device across the series of flyovers). In some examples, data transmission profiles of devices and/or cluster (e.g., IoT sensors) may be predictable upon observation. For example, data transmission patterns may predictably vary based on factors such as time of day, day of week, etc. Utilizing this method, satellite 402 may predict an amount of data that each device and/or cluster may need to transmit during each of its flyovers. As such, satellite 402 may predict an optimized TxW before satellite 402 comes into communication range of that device and/or cluster on each pass. This means that TxW assignments may be calculated and/or modified even in the absence of a request from the devices to receive the assignments.

As a particular satellite (e.g., satellite 402) learns this data (e.g., a data transmission profile, a TxW assigned to each device and/or cluster, etc.), it may be shared with other satellites in a constellation of satellites. As such, all the satellites in a constellation may use common parameters for data communication and/or may a contribute to a continual improvement of assigned TxWs to adapt to changing conditions in satellite communication network 400. For example, as time passes and a transmission profile of a device and/or cluster changes, satellite 402 may record these changes and/or adapt the corresponding TxW to the changes. Thus, each time a satellite comes into communication range of a device and/or cluster, satellite 402 may automatically and/or immediately provide an updated or refined TxW based on its historic data traffic profile. This may also occur as new devices and/or clusters are introduced and/or older ones are deprecated.

Satellite 402 may be in communication range of multiple devices and/or clusters at once while in various parts of its orbit. Satellite 402 may structure the TxW for each of these multiple devices and/or clusters based on their proximity and/or typical data traffic profile. The TxWs of the devices may be structured to provide optimal transmission of data as satellite 402 passes overhead. In this manner, simultaneous communication to satellite 402 from multiple devices and/or clusters may be avoided, thus avoiding the problem of interference and/or channel saturation from this type of transmission.

For devices and/or clusters with overlapping SIAs (e.g., devices and/or clusters in the same city, etc.), neighboring devices and/or clusters may be granted the same TxW (e.g., meaning that they must contend for access to the satellite 402). Conversely, they may be given different non-overlapping TxWs to prevent collisions. For example, first device 404-1 and second device 404-2 may be assigned non-overlapping TxWs of first TxW 426-1 and second TxW 426-2.

In various embodiments, variations in the local topology where devices and/or clusters are located may be computationally addressed. For example, a device and/or cluster may be located near a signal obstacle (e.g., a building a tree, a hill, etc.) which may reduce the effective satellite communication range with respect to that device and/or cluster. Multiple communication windows may exist for each device and/or cluster location. For example, a device and/or cluster located in San Jose, California may have around thirty TxWs for Apr. 11, 2022, each from 10 to 30 minutes in duration and may have a maximum elevation from 11 to 72 degrees. In such a case, a pre-calculated TxW based on theoretical visibility of the device and/or cluster may not work if some topology features obstruct transmission. Satellite 402 and/or a control station may collect information about all successful transmissions and, utilizing a machine-learning (ML) algorithm, predict using combinations of angles, elevations, and other relevant parameters “clear”/non-obstructed transmission windows. In the learning time the device and/or cluster may try to connect for each predicted window. An obstruction zone may be computationally learned from the calculations and/or observations of communications. As a result, the device and/or cluster may be configured to wake up and transmit only when a probability of the successful transmission is above a certain threshold.

Upon receiving an assigned communication resource allocation, the receiving device may begin to utilize the assigned communication resource allocation. For example, a device receiving a TxW assignment may begin to utilize that TxW for its data communication with satellite 402. In an example, first device 404-1 may, at 429, transmit its data within its assigned first TxW 426-1. In addition, second device 404-2 may transmit its data within its assigned second TxW 426-2. Second device 404-2 may terminate its data transmissions at or before handoff point 428 and/or first device 404-1 may begin its data transmissions at or after handoff point 428. The devices and/or clusters may continue to operate within their assigned TxWs until updated TxWs are provided and/or their configurations are lost. Since the assigned TxWs are configured to avoid data collisions, satellite communication network 400 may operate in a manner that avoids simultaneous communication with satellite 402 and/or may dynamically adjust to changing network conditions and participants.

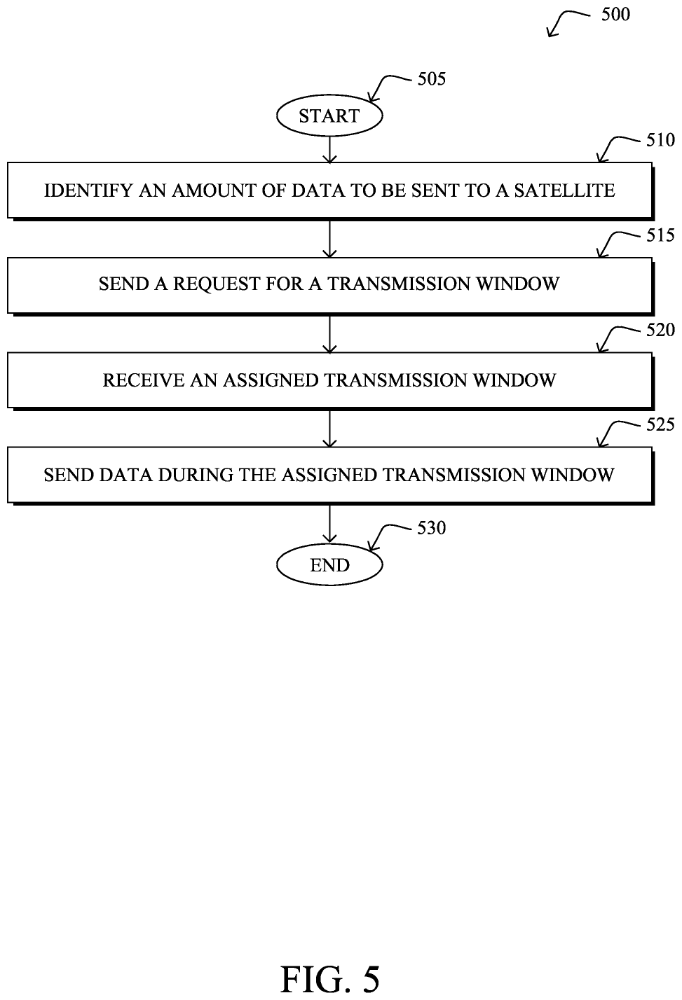

FIG. 5 illustrates an example simplified procedure (e.g., a method) for automated configuration of device wake schedules for satellite communications, in accordance with one or more embodiments described herein. For example, a non-generic, specifically configured device (e.g., device 200), may perform procedure 500 by executing stored instructions (e.g., transmission window assignment process 248). The procedure 500 may start at step 505, and continues to step 510, where, as described in greater detail above, a device associated with a first cluster of data sources may identify an amount of data from the first cluster of data sources to be sent by the device to a satellite. The data to be sent may be sensor data capture by the first cluster of data sources. The satellite may be a low-earth orbit satellite.

At step 515, as detailed above, the device may send a request to the satellite for a transmission window that indicates the amount of data to be sent by the device to the satellite. Additionally, the request may include an identifier for the first cluster of data sources.

At step 520, where, as detailed above, the device may receive, from the satellite, an indication of an assigned transmission window during which the device may transmit data to the satellite. The satellite may compute the assigned transmission window of the device based on the amount of data to be sent by the device to the satellite and such that the assigned transmission window of the device does not overlap an assigned transmission window of a neighboring device associated with a second cluster of data sources. The device associated with the first cluster of data sources may not have knowledge of the neighboring device associated with the second cluster of data sources.

The satellite may compute the assigned transmission window of the device associated with the first cluster of data sources based further in part on a location associated with the identifier sent in the request. The satellite may compute the assigned transmission window of the device associated with the first cluster of data sources based on a proximity of the satellite to the device associated with the first cluster of data sources.

The device associated with the first cluster of data sources and the neighboring device associated with the second cluster of data sources may have overlapping potential communication windows. The assigned transmission window of the device associated with the first cluster of data sources may be a subset of a potential communication window for the device associated with the first cluster of data sources. The assigned transmission window of the neighboring device may partially overlap the potential communication window of the device associated with the first cluster of data sources.

At step 525, where, as detailed above, the device may send, during the assigned transmission window of the device, the data from the first cluster of data sources towards the satellite. Additionally, an indication of an updated transmission window for the device associated with the first cluster of data sources may be received. The updated transmission window may be computed for the device associated with the first cluster of data sources in response to a request from a second neighboring device associated with a third cluster for a transmission window. Device may then begin to operate using the updated transmission window (e.g., send, during the updated transmission window, the data from the first cluster of data sources towards the satellite). In this manner, a satellite communication network may automatically and dynamically adapt to changing network conditions and/or participants.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a mechanism to facilitate satellite communication resource allocation to devices and/or clusters of devices. By leveraging the holistic view of the network afforded to the satellite to compute resource allocations that avoid data collisions and channel saturation, a satellite communication network employing these techniques may be operated in a manner that efficiently deploys its communication resources to provide the highest amount of data throughput with a lowest probability of data transmission failure. Moreover, these techniques achieve these goals even in areas of densely deployed and/or operated devices and/or clusters of devices which may have overlapping satellite communication resource demands (e.g., overlapping potential communication windows). In addition, these techniques allow for a satellite communication to dynamically adjust its satellite communication resource allocation to adapt to changing network conditions and/or participants.

While there have been shown and described illustrative embodiments that provide automated computation of transmission windows for satellite communications, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well. In addition, while certain types of devices and/or groupings of devices are discussed herein, the techniques herein may be used in conjunction with any devices and/or groupings of devices.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
identifying, by a device associated with a first cluster of data sources, an amount of data from the first cluster of data sources to be sent by the device to a satellite;
sending, by the device and to the satellite, a request for a transmission window that indicates the amount of data to be sent by the device to the satellite;
receiving, at the device and from the satellite, an indication of an assigned transmission window during which the device may transmit data to the satellite, wherein the satellite computes the assigned transmission window of the device based on the amount of data to be sent by the device to the satellite and such that the assigned transmission window of the device does not overlap an assigned transmission window of a neighboring device associated with a second cluster of data sources; and
sending, by the device and during the assigned transmission window of the device, the data from the first cluster of data sources towards the satellite.

2. The method as in claim 1, wherein the request includes an identifier for the first cluster of data sources and wherein the satellite computes the assigned transmission window of the device associated with the first cluster of data sources based further in part on a location associated with the identifier.

3. The method as in claim 1, wherein the assigned transmission window of the device associated with the first cluster of data sources is a subset of a potential communication window for the device associated with the first cluster of data sources.

4. The method as in claim 3, wherein the assigned transmission window of the neighboring device partially overlaps the potential communication window of the device associated with the first cluster of data sources.

5. The method as in claim 1, further comprising:
receiving an indication of an updated transmission window for the device associated with the first cluster of data sources, wherein the satellite computes the updated transmission window for the device associated with the first cluster of data sources in response to a request from a second neighboring device associated with a third cluster for a transmission window.

6. The method as in claim 1, wherein the data to be sent comprises sensor data captured by the first cluster of data sources.

7. The method as in claim 1, wherein the satellite computes the assigned transmission window of the device associated with the first cluster of data sources based on a proximity of the satellite to the device associated with the first cluster of data sources.

8. The method as in claim 1, wherein the device associated with the first cluster of data sources does not have knowledge of the neighboring device associated with the second cluster of data sources.

9. The method as in claim 1, wherein the device associated with the first cluster of data sources and the neighboring device associated with the second cluster of data sources have overlapping potential communication windows.

10. The method as in claim 1, wherein the satellite is a low-earth orbit satellite.

11. An apparatus, comprising:
one or more network interfaces;
a processor coupled to the one or more network interfaces and configured to execute one or more processes; and
a memory configured to store a process that is executable by the processor, the process when executed configured to:
identify an amount of data from a first cluster of data sources to be sent by the apparatus to a satellite, wherein the apparatus is associated with the first cluster of data sources;
send, to the satellite, a request for a transmission window that indicates the amount of data to be sent by the apparatus to the satellite;
receive, from the satellite, an indication of an assigned transmission window during which the apparatus may transmit data to the satellite, wherein the satellite computes the assigned transmission window of the apparatus based on the amount of data to be sent by the apparatus to the satellite and such that the assigned transmission window of the apparatus does not overlap an assigned transmission window of a neighboring apparatus associated with a second cluster of data sources; and
sending, during the assigned transmission window of the apparatus, the data from the first cluster of data sources towards the satellite.

12. The apparatus as in claim 11, wherein the request includes an identifier for the first cluster of data sources and wherein the satellite computes the assigned transmission window of the apparatus based further in part on a location associated with the identifier.

13. The apparatus as in claim 11, wherein the assigned transmission window of the apparatus associated with the first cluster of data sources is a subset of a potential communication window for the apparatus associated with the first cluster of data sources.

14. The apparatus as in claim 13, wherein the assigned transmission window of the neighboring apparatus partially overlaps the potential communication window of the apparatus associated with the first cluster of data sources.

15. The apparatus as in claim 11, wherein the process when executed is further configured to:
receive an indication of an updated transmission window for the apparatus associated with the first cluster of data sources, wherein the satellite computes the updated transmission window for the apparatus associated with the first cluster of data sources in response to a request from a second neighboring apparatus associated with a third cluster for a transmission window.

16. The apparatus as in claim 11, wherein the data to be sent comprises sensor data captured by the first cluster of data sources.

17. The apparatus as in claim 11, wherein the satellite computes the assigned transmission window of the apparatus associated with the first cluster of data sources based on a proximity of the satellite to the apparatus associated with the first cluster of data sources.

18. The apparatus as in claim 11, wherein the apparatus associated with the first cluster of data sources does not have knowledge of the neighboring apparatus associated with the second cluster of data sources.

19. The apparatus as in claim 11, wherein the apparatus associated with the first cluster of data sources and the neighboring apparatus associated with the second cluster of data sources have overlapping potential communication windows.

20. A tangible, non-transitory, computer-readable medium storing program instructions that cause a device in a network to execute a process comprising:
identifying, by the device associated with a first cluster of data sources, an amount of data from the first cluster of data sources to be sent by the device to a satellite;
sending, by the device and to the satellite, a request for a transmission window that indicates the amount of data to be sent by the device to the satellite;
receiving, at the device and from the satellite, an indication of an assigned transmission window during which the device may transmit data to the satellite, wherein the satellite computes the assigned transmission window of the device based on the amount of data to be sent by the device to the satellite and such that the assigned transmission window of the device does not overlap an assigned transmission window of a neighboring device associated with a second cluster of data sources; and
sending, by the device and during the assigned transmission window of the device, the data from the first cluster of data sources towards the satellite.
